(19) United States
(12) Patent Application Publication
(10) Pub. No.: US 2009/0111426 A1
(43) Pub. Date: Apr. 30, 2009

(54) SYSTEM AND METHOD FOR CONTROLLING COMMUNICATION TIME

(75) Inventor: CHIH-LUNG LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/143,844

(22) Filed: Jun. 23, 2008

(30) Foreign Application Priority Data
Oct. 26, 2007 (CN) 200710202289.5

(51) Int. Cl. H04M 1/66

(52) U.S. Cl. 455/411

(57) ABSTRACT

An exemplary method for controlling communication time includes the following steps of: selecting one or more contacts of a contact list stored in a mobile phone as unrestricted contacts; selecting one of the unrestricted contacts to set up a privileged account of the mobile phone; setting a time limit that controls a total communication time of the mobile phone to communicate with restricted contacts; using the mobile phone to communicate with one of the contacts; detecting whether the communication is with one of the unrestricted contacts or the restricted contacts; counting downing a remaining time limit if the communication is with one of the restricted contacts; detecting whether the remaining time limit has reached zero; and disconnecting the communication when the time limit has reached zero.

### BACKGROUND

1. Field of the Invention

The present invention relates to systems and methods for managing communications between mobile phones, and particularly to a system and method for controlling communication time of the mobile phones.

2. Description of related art

With rapid development of communication, portable electronic devices, such as mobile phones are now in widespread use. In the past, the cost of mobile phones and communication services were prohibitive and this limit the number of mobile phone to the financially able. In recent years, the cost of mobile phones have fallen steeply, and mobile phones are now more affordable and having more functionality. Indeed, mobile phones are so ubiquitous that high school students and even kindergarten kids are entrusted with mobile phones by their parents.

However, some of these adolescent and kindergarten students may not understand or be aware of mobile phone charges, and thus may use their mobile phones indiscriminately, which may result in heavy phone charges.

Accordingly, what is needed is a system and method for controlling the communication time of mobile phones.

### SUMMARY

An exemplary method for controlling communication time is provided. The method includes the following steps of: selecting one or more contacts of a contact list stored in a mobile phone as unrestricted contacts; selecting one of the unrestricted contacts to set up a privileged account of the mobile phone; setting a time limit that controls a total communication time of the mobile phone to communicate with restricted contacts; using the mobile phone to communicate with one of the contacts; detecting whether the communication is with one of the unrestricted contacts or the restricted contacts; counting downing a remaining time limit if the communication is with one of the restricted contacts; detecting whether the remaining time limit has reached zero; and disconnecting the communication when the time limit has reached zero.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 is a functional block diagram illustrating a system for controlling communication time in accordance with an exemplary embodiment.

FIG. 2 is a diagram illustrating a user interface provided by the system of FIG. 1.

FIG. 3 is a flow chart illustrating a method for controlling communication time in accordance with another exemplary embodiment.

### DETAILED DESCRIPTION OF THE EMBODIMENTS

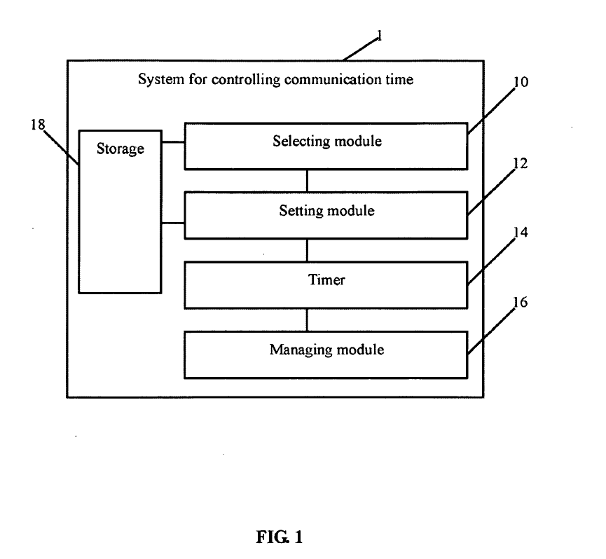

FIG. 1 is a functional block diagram illustrating a system for controlling communication time (hereinafter, “the system 1”) in accordance with an exemplary embodiment. The system 1 is installed and executed in a mobile phone (not shown in FIG. 1), which is configured for managing contacts of the mobile phone and controlling the communication time of the mobile phone. The system 1 provides an interactive user interface for operating functions of the mobile phone, and typically includes a selecting module 10, a setting module 12, a timer 14, and a managing module 16.

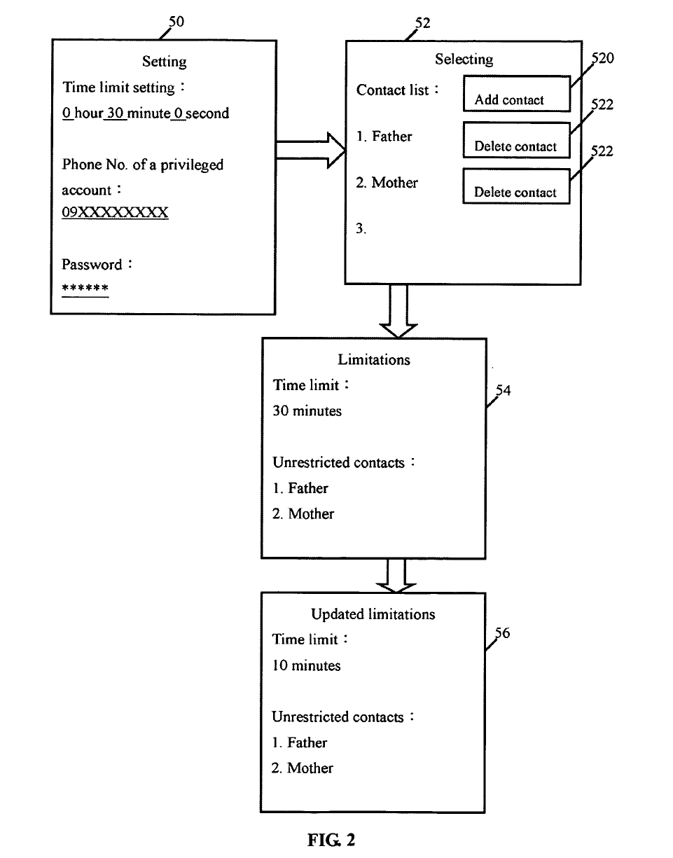

The selecting module 10 is configured for selecting one or more contacts of a contact list stored in the mobile phone as unrestricted contacts. In the exemplary embodiment, the unrestricted contacts are selected by inputting phone numbers and other information of the unrestricted contacts into the mobile phone. As shown in FIG. 2, the unrestricted contacts are managed in a selecting interface 52, by clicking an add contact icon 520 or a delete contact icon 522.

The setting module 12 is configured for selecting one of the unrestricted contacts to set up a privileged account with a password. The privileged account is related with the phone number of one of the unrestricted contacts. In the exemplary embodiment, when the unrestricted contacts need to be modified/updated, the password needs to be entered for verification and access.

The setting module 12 is further configured for setting a time limit that controls a total communication time of the mobile phone to communicate with restricted contacts. For example, as shown in the setting interface 50, the time limit is set as 30 minutes. In the exemplary embodiment, the communication time between the mobile phone and the unrestricted contacts is ignored. In other words, when the mobile phone is used to communicate with the unrestricted contacts, the time limit is not reduced. Furthermore, even when the time limit has reached zero the mobile phone is still capable of communicating with the unrestricted contacts. However, when the communication time limit is reached, communications with the restricted contacts will be denied or will be disconnected if connected.

The managing module 16 is configured for managing communications when the mobile phone is used to communicate with the restricted contacts according to the time limit. The managing module 16 may manage the communications by first detecting whether the mobile phone is used to communicate with the unrestricted contacts or the restricted contacts.

The managing module 16 detects that the contact is restricted or unrestricted when the callee answers the communication. If the callee is an unrestricted contact, the time limit is unchanged. Otherwise, the timer 14 starts counting downing a remaining time limit when the mobile phone is used to communicate with the restricted contacts. When the time limit reaches zero, the managing module 16 disconnects the communication with the restricted contact. Prior to disconnection, the managing module 16 may also activate an alarm indicating that the communication with the restricted contact will be disconnected. The alarm may be a visual, audible, or a vibrating alarm or a combination.

In addition, when the time limit has reached zero, the managing module 16 is configured for resetting the time limit. The managing module 16 first informs the privileged account to reset the time limit. This can be done by manually calling or sending a SMS text message to the phone number of the privileged account. Then the managing module 16 waits until receiving a resetting text message, which includes the password from the privileged account. The managing module 16 identifies the resetting text message according to the password. The managing module 16 reads the text message to detect that the resetting text message is from the phone number of the privileged account and verifies the password, before resetting the time limit automatically. In the exemplary embodiment, the reset time limit defaults to the original time limit. The time limit may also be reset manually through the user interface provided by the system 1.

If the time limit has not reached zero when the managing module 16 receives the resetting text message including the password, the remaining time limit of the mobile phone would be replaced with the reset time limit. For example, the reset time limit is 30 minutes, the remaining time limit is 5 minutes when receiving the resetting text message including the password, and then the managing module 16 changes the time limit of the mobile phone to be 30 minutes automatically.

In the exemplary embodiment, the resetting text message is not displayed nor stored in a message history of the mobile phone so as to avoid the password from being deciphered. The resetting text message including the password may be encrypted or decrypted.

In the exemplary embodiment, emergency phone numbers (i.e., 911) are pre-configured as the unrestricted contacts, which is not controlled by the time limit.

The system 1 may also include a storing module 18 for storing various kinds of data, such as the phone numbers, the unrestricted contacts, the time limit, the communication time, and so on.

FIG. 2 is a schematic diagram illustrating the user interface provided by the system of FIG. 1. The user interface may include, but not limited to, the setting interface 50, the selecting interface 52, a limitations interface 54, and an updated limitations interface 56.

In the setting interface 50, the time limit, the phone number of the privileged account, and the password may be set through the setting module 12.

In the selecting interface 52, the contacts in the contact list may be selected or changed by clicking the add contact icon 520 or delete contact icon 522 through the selecting module 10. As shown in the selecting interface 52, an example of the main user of the mobile phone may be a financially dependent minor, and the unrestricted contacts may be the parent of the main user.

In the limitations interface 54, the time limit and the unrestricted contacts are shown. If the mobile phone has communicated with the restricted contacts, the updated limitations are shown in the updated limitations interface 56, such as the remaining time limit.

In other embodiments, the user interface may provide other kinds of interfaces for presenting relevant information, such as an interface for listing the call history of the mobile phone, a activate interface for presenting the activate information, and so on.

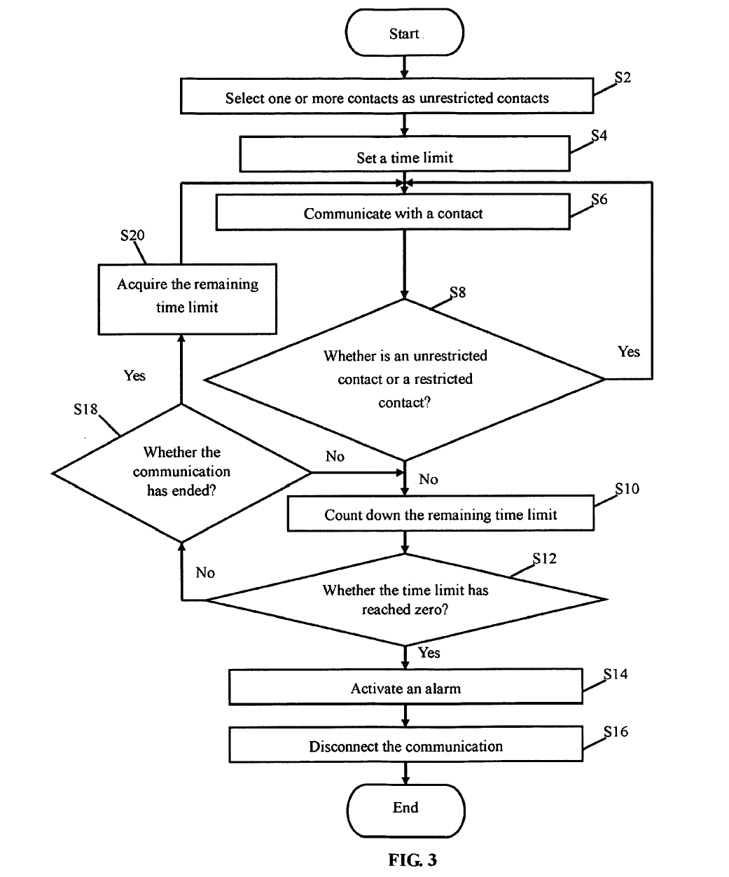

FIG. 3 is a flow chart illustrating a method for controlling communication time in accordance with another exemplary embodiment. In step S2, the selecting module 10 selects one or more contacts of the contact list stored in the mobile phone as the unrestricted contacts. In the exemplary embodiment, the unrestricted contacts are selected by inputting the phone numbers and/or other information of the unrestricted contacts into the mobile phone.

In step S4, the setting module 12 selects one of the unrestricted contacts to set up the privileged account with the password, and sets the time limit that controls the total communication time of the mobile phone to communicate with the restricted contacts. The privileged account is related with the phone number of one of the unrestricted contacts.

In step S6, the mobile phone is used to communicate with one of the contacts by dialing out/calling.

In step S8, the managing module 16 detects whether the mobile phone is used to communicate with the unrestricted contacts or the restricted contacts.

If the managing module 16 detects that the mobile phone is used to communicate with the restricted contact, in step S10, the timer 14 starts counting down the remaining time limit by utilize the timer 14 once the communication with the unrestricted contact is answered. Otherwise, if the mobile phone is used to communicate with the unrestricted contact, the procedure returns to step S6.

In step S12, the managing module 16 detects whether the time limit has reached zero. When the time limit has reached zero, in step S14, the managing module 16 activates the alarm indicating that the communication with the restricted contact will be disconnected. In step SI 6, the managing module 16 discontinues the communication with the restricted contact after activated the alarm.

If the time limit has not reached zero, in step S18, the managing module 16 detects whether the communication has ended. If the communication has not ended, the procedure returns to step S10 for continuing counting down the remaining time limit by utilize the timer 14. Otherwise, if the communication has ended, in step S20, the managing module 16 acquires the remaining time limit through the timer 14, and then the procedure returns to step S6.

It should be emphasized that the above-described embodiments, particularly, any “exemplary” embodiments, are merely possible examples of implementations, and set forth for a clear understanding of the principles of the invention. Many variations and modifications may be made to the above-described exemplary embodiment(s) without departing substantially from the spirit and principles of the invention. All such modifications and variations are intended to be included herein within the scope of this disclosure and the above-described exemplary embodiment(s), and the present invention is protected by the following claims.

What is claimed is:

1. A system for controlling communication time, the system being installed in a mobile phone, the system comprising:
a selecting module configured for selecting one or more contacts of a contact list stored in the mobile phone as unrestricted contacts;
a setting module configured for selecting one of the unrestricted contacts to set up a privileged account of the mobile phone, and setting a time limit that controls a total communication time of the mobile phone to communicate with restricted contacts; and
a managing module configured for managing the communication when the mobile phone is used to communicate with the restricted contacts, according to the time limit.

2. The system as claimed in claim 1, wherein the managing module is further configured for disconnecting the communication with the restricted contacts when the time limit has reached zero.

3. The system as claimed in claim 2, wherein the managing module is further configured for activating an alarm indicating that the communication with the restricted contact will be disconnected.

4. The system as claimed in claim 1, further comprising a timer configured for counting downing a remaining time limit when the mobile phone is used to communicate with the restricted contacts.

5. The system as claimed in claim 1, wherein the setting module is further configured for setting a password of the privileged account, which is related with the phone number of one of the unrestricted contacts.

6. The system as claimed in claim 5, wherein the setting module is further configured for resetting the time limit by:
receiving a resetting text message comprising the password;
detecting the resetting text message is from the privileged account; and
verifying the password in the resetting text message, and resetting the time limit automatically.

7. The system as claimed in claim 6, wherein the reset time limit defaults to the original time limit.

8. The system as claimed in claim 1, further comprising a storing module for storing information of the unrestricted contacts and the restricted contacts, the time limit, and the communication time.

9. A method for controlling communication time, the method comprising:
selecting one or more contacts of a contact list stored in a mobile phone as unrestricted contacts;
selecting one of the unrestricted contacts to set up a privileged account of the mobile phone;
setting a time limit that controls a total communication time of the mobile phone to communicate with restricted contacts;
using the mobile phone to communicate with one of the contacts;
detecting whether the communication is with one of the unrestricted contacts or the restricted contacts;
counting downing a remaining time limit if the communication is with one of the restricted contacts;
detecting whether the remaining time limit has reached zero; and
disconnecting the communication when the time limit has reached zero.

10. The method according to claim 9, further comprising:
detecting whether the communication has ended; and
acquiring the remaining time limit if the communication has ended.

11. The method according to claim 9, further comprising:
activating an alarm indicating that the call to the restricted contact will be disconnected.

12. The method according to claim 9, wherein the setting step comprises:
setting a password of the privileged account, which is related with the phone number of one of the unrestricted contacts.

13. The method according to claim 12, further comprising:
resetting the time limit when the time limit has reached zero.

14. The method according to claim 13, wherein the step of resetting the time limit comprises:
receiving a resetting text message comprising the password;
detecting the resetting text message is from the privileged account; and
verifying the password in the resetting text message, and resetting the time limit automatically.

15. The method according to claim 14, wherein the reset time limit defaults to the original time limit.
